(19) United States
(12) Patent Application Publication
(10) Pub. No.: US 2015/0088436 A1
(43) Pub. Date: Mar. 26, 2015

(54) Customer-specific configuration and parameterisation of level measurement devices during the ordering process

(71) Applicant: VEGA Grieshaber KG, Wolfach (DE)

(72) Inventors: Ralf SCHAETZLE, Fisherbach (DE); Fridolin Faist, Oberwolfach (DE)

(21) Appl. No.: 14/480,034

(22) Filed: Sep. 8, 2014

(30) Foreign Application Priority Data
Sep. 20, 2013 (DE) 10 2013 218 971.0

(51) Int. Cl. G01F 23/00

(52) U.S. Cl. CPC G01F 23/00
USPC 702/55

(57) ABSTRACT

A level measurement device parameterisation system for configuring and/or parameterising a level measurement device includes a user computer and a central computer. The user computer creates configuration instructions and parameterisation instructions on the basis of user inputs and the central computer creates, on the basis thereof, at least part of the configuration information and/or parameterisation information for a level measurement device. The central computer is further configured to transmit control information to the user computer to provide the user interface.

### REFERENCE TO RELATED APPLICATIONS

This application claims the benefit of the filing date of German Patent Application Serial No. DE 10 2013 218 971.0 filed on 20 Sep. 2013, the disclosure of which is hereby incorporated herein by reference.

### FIELD OF THE INVENTION

The invention relates to level measurement. In particular, the invention relates to a level measurement device parameterisation system for configuring and/or parameterising a level measurement device. The invention further relates to a method for creating configuration information and/or parameterisation information of a level measurement device, to a program element and to a computer-readable medium.

### BACKGROUND OF THE INVENTION

For continuous level determination in containers, which may for example contain liquids or bulk materials, sensors are often used, and are available in various embodiments and may additionally have different settings and parameters in each case depending on the situation of use. This plurality of configuration and parameterisation options may in many cases necessitate increased outlay during setup. Modern level measurement devices may often have a plurality of different parameters, dependencies and setting options. In particular if a relatively large number of level measurement devices are used, for example in production settings having a plurality of containers, efficient setup and maintenance of the level measurement devices may be important.

### SUMMARY OF THE INVENTION

A level measurement device parameterisation system which is configured to be used during and directly after ordering of a level measurement device, for configuring and/or parameterising the level measurement device is proposed, which comprises a user computer having a user interface and a central computer. There is a data communications link between the central computer and the user computer. The user computer is configured to create configuration instructions and parameterisation instructions on the basis of user inputs via the user interface, and to transmit them to the central computer. The central computer is configured to transmit control information for preparing, i.e. creating, the user interface to the user computer, and to create at least part of the configuration information and/or parameterisation information for a level measurement device on the basis of the configuration instructions and parameterisation instructions.

One advantage is that, as a result of the configuration information and parameterisation information being created at a central computer instance, installation and maintenance outlay during the preparation of the configuration and parameterisation system for the user can be reduced. A further advantage is that the user need not necessarily be at or near to the level measurement device, and this can increase the user's flexibility during the configuration and parameterisation of level measurement devices.

For example, the user computer and the central computer may cooperate in a client-server architecture. In one example, the central computer is in a computing centre, and the user computer communicates with the central computer via a data network using software installed locally on the user computer. In a further example, the central computer is located in the computing centre, and the user computer accesses functions of the central computer in the computing centre by means of a communications application. A Windows-based system would be possible as an operating system at the user end.

Configuration (in this context also called assembling) is a process which is carried out after ordering of a filling level measurement device and results in a particular arrangement of modules or hardware components, which as a whole form the level measurement device. In this context, the respective technical parts and components or modules or elements may already contain some software components and/or have an initial parameterisation upon delivery.

Parameterisation, as opposed to configuration, may be understood to mean setting and managing particular changeable settings or variables. These parameters may in many cases depend on the specific field or purpose of use, and for example establish the variables required for determining a fill level, such as container size or type of filling material.

A user computer may be understood to mean a data processing unit which the user can use in a mobile or stationary manner during level measurement device management. These may be commercial stationary or portable PCs having appropriate user interfaces, such as a keyboard, a mouse or the like. A further possibility is additional software which can carry out the appropriate input interactions in the place of a human user. In one example, a user computer is a portable laptop computer having an input option via a mouse and a keyboard.

A central computer may be understood for example to mean a server, which is located in a computing centre and which provides all the necessary components required for providing the system functions, for example a memory and a processor.

A data communications link may for example be understood to mean an Internet protocol link via the public Internet. Point-to-point connections or data links via separate, private data networks, which may also transmit the data in encrypted form, are also possible.

Configuration and parameterisation instructions may for example be understood to mean information transmitted in a particular defined format, which the user computer creates on the basis of the user's inputs and selection decisions and transmits to the central computer via the data communications connection. This information can be used by the central computer in relation to the configuration or parameterisation decisions made by the user so as to create the configuration information and/or parameterisation information.

The control information transmitted by the central computer to provide the user interface contains for example instructions for creating a graphical user interface on a display device of the user computer. For example, this may be HTML-based information, but also for example Java or similar scripting or programming languages. In any case, the user computer is configured in such a way that the outlay for installation and the outlay for preparing intelligent program functions on the local user computer can be kept to a minimum. This can reduce the maintenance outlay and the costs of providing the user computer.

The central computer is configured to create for example a configuration file for a particular level measurement device, which file contains at least some of the entirety of the possible configuration possibilities or parameter settings. For example, in some cases setting some selected parameters may be sufficient to enable a basic function for level measurement.

In one embodiment of the invention, the central computer is configured to create complete configuration information and/or parameterisation information for the level measurement device on the basis of the configuration instructions and parameterisation instructions.

An advantage of creating complete configuration information is that no further additional configuration or parameterisation need be required, for example when the level measurement device is installed in its final place of use. For example, as early as the ordering process for the level measurement device, in particular within an ordering application, a complete set of configuration information and/or parameterisation information may be created, and may if appropriate be transferred into the level measurement device before the level measurement device is actually delivered. In other words, the time and outlay for setup can thus be reduced, since additional parameterisation and/or configuration on site is made unnecessary.

In one embodiment of the invention, the central computer and the user computer are further configured to create the configuration information and/or parameterisation information by way of functionalities of a level measurement device manager.

In this context, a level measurement device manager may be understood to mean an application or software which for example provides a user interface for determining settings, which makes it possible to determine all of the parameters of a device by way of user inputs and for example additionally to save them in a corresponding file (known as instance data). Applications of this type are also known as device type managers, which may for example be embedded as modular applications in superordinate framework applications. These framework applications are also known as field device tools (FDTs). For example, FDT framework applications of this type are known by the names PACTware, Fieldcare, Freelance and Fieldmate.

In other words, an advantage of using functionalities of a level measurement device manager is that a pre-existing software component for device configuration and device management can also be used for third-party applications. For example, ordering software may for example call up a device type manager from the ordering software at the user's initiation. In this way, using the same user interface, which is familiar to him, of the device type manager, a customer can actuate all of the settings for the ordered device as he desires, and generate the created configuration and parameterisation as early as during the ordering process.

A further advantage is that in the event of changes, which occur for example as a result of new functionalities of the level measurement device, no separate or additional changes need to be implemented in the framework applications, in particular the ordering software. This can reduce the maintenance outlay and thus the costs for the framework applications when providing the parameterisation and configuration functionalities.

In one embodiment of the invention, the user interface of the user computer is configured to provide a user with all the necessary functions of the level measurement device manager for creating the complete configuration information and/or parameterisation information. In other words, the user interface provides the user with substantially all of the functions which are already present in the level measurement device manager (for example in a device type manager) and may already be assigned to the user. In this context, in one example, an application for the level measurement device manager may for example be implemented as a centralised instance for example in a computing centre on the same or on a further central computer, in such a way that the level measurement device manager is only provided at one central location, and third-party applications can access this centralised instance. This may have the advantage that, instead of a plurality of distributed installed level measurement device managers, just one centralised instance is provided for all third-party applications. Any required updates or changes to the functionality of the level measurement device manager are thus immediately available to all participating framework applications, including for example the ordering software. This can greatly reduce the outlay for maintenance and updating and thus the costs.

In one embodiment of the invention, the configuration of the user interface of the user computer substantially corresponds to the configuration of a user interface of the level measurement device manager. This configuration may for example be the presentation of a graphical user interface on the display device of the user computer or else operating instructions or operating commands, such as mouse movements, keyboard shortcuts or the like. In other words, the user is provided with a user interface which substantially corresponds to the familiar appearance and to the functionalities of the level measurement device manager (for example device type manager). This may have the advantage that a user, for example during the ordering process, is not confronted with new or different functionalities or user interfaces, but can access a user interface familiar to him. This may have the advantage that temporal sequences such as an ordering process can be simplified and shortened.

According to one embodiment of the invention, the user computer and the central computer are configured to provide the user interface on the user computer independently of the operating system. An advantage of an operating-system-independent user interface may be in particular a lower installation and maintenance outlay for the user computer and the option of using different types of operating systems on the user computer. These operating systems may for example be Microsoft Windows, Linux, MacOS or comparable operating systems, including tablet operating systems such as Android or IOS.

Provision independently of the operating system may be understood to mean use of pre-installed applications of a standardised technical configuration. These may for example be remote access programs (for example remote access or terminal applications), but may also be HTML-based applications such as a standard Web browser.

According to one embodiment of the invention, the level measurement device parameterisation system on the user computer and on the central computer is configured as a Web application. In this context, the central computer may comprise a Web server and a Web application which communicate with the user computer via the data communications link. In this context, all essential functionalities of the level measurement device manager are for example implemented in the Web application on the central computer, and the Web server serves as a communications connection between the user computer and the Web application. In other words, all essential intelligent functionalities are implemented in a centralised manner in the central computer as a Web application or as a Web server.

On the user computer, a Web browser pre-installed with the operating system for example may be used as the user interface, which is controlled by the control information from the Web server.

This may be done for example using HTML-, XML- and/or Java-based protocols. Web applications, as an operating-system-independent variant implementation, can simplify the installation and maintenance outlay in the user computer, and thus render local, separate application software installed on the user computer superfluous.

In one embodiment of the invention, the level measurement device parameterisation system further comprises a storage unit, which is configured to store configuration information and/or parameterisation information created by the central computer. The possibility of storage means that previously created configuration information and/or parameterisation information can advantageously be used in other applications or for further purposes, without the need to access the level measurement device manager itself.

For example, by way of an export function of the level measurement device manager, configuration information and/or parameterisation information created on the central computer can be stored on a hard disk, USB drive or similar memory in the form of a file. For example, complete configuration information and parameterisation information created by way of the level measurement device manager during the ordering process can be stored as a file and be transferred to the relevant level measurement device before the device is delivered to the customer. This can make immediate use possible at the target location without reconfiguration or reparameterisation.

Storage of the configuration information and parameterisation information created in the central computer may for example similarly or additionally be made available on the user computer. In this context, the storage unit may be connected either to the central computer or to the user computer, and comprise all types of data memories, such as hard disk memories, temporarily connectable memories, such as USB sticks, RAM, or comparable media.

One aspect of the invention proposes a method for creating complete configuration information and/or parameterisation information of a level measurement device. The method comprises the step of providing a Web application on a central computer. The Web application comprises at least all the functions of a level measurement device manager which are required for creating complete configuration information and/or parameterisation information. A further step consists in the central computer transmitting control information to the user computer to provide the user interface. An operating-system-independent user interface is further provided on a user computer. In a further step, a data communications link is established between the user computer and the central computer. In a further step, configuration instructions and parameterisation instructions are created, which are based on user inputs via the user interface on the user computer. The next step involves transmitting the configuration instructions and parameterisation instructions from the user computer to the central computer. The method further comprises the step of the central computer creating complete configuration information and/or parameterisation information for a level measurement device, the creation being based on the transmitted configuration instructions and parameterisation instructions.

In one embodiment of the invention, the method additionally comprises the step of storing the configuration information and/or parameterisation information in a storage unit, which can be connected to the central computer and/or to the user computer and which is configured to store configuration information and parameterisation information.

In one embodiment of the invention, the method additionally comprises the step of transferring configuration information and/or parameterisation information, created by the central computer and/or stored in the storage unit, into a level measurement device. In other words, the created parameterisation information and configuration information are transferred into the control electronics of the level measurement device, for example as a configuration file, by means of suitable data transfer devices. In one example, the configuration file is transferred into a flash memory of the level measurement device via a cable connection. One advantage is that, as a result, the final configuration and parameterisation take place prior to installation, for example before a level measurement device is delivered to a customer, and no further configuration or parameterisation may be required at the installation site.

In one embodiment of the invention, the operating-system-independent user interface is provided on the user computer from a framework application. In one example, the framework application is an ordering software or ordering application in which a customer or employee defines, configures and parameterises a level measurement device. In this context a device type manager for example can be called up from the ordering application, for example by actuating a button on the graphical user interface.

In one embodiment of the invention, storing the configuration information and/or parameterisation information comprises providing the created configuration information and/or parameterisation information for the framework application. In other words, the created configuration information and/or parameterisation information can be processed further in the framework application, for example an ordering application. In a further example, a created configuration information and/or parameterisation information file can be stored together with a purchase order which has been created in the ordering application.

One aspect of the invention further proposes a program element for creating configuration information and/or parameterisation information for a level measurement device, which carries out the steps of the above-disclosed method when implemented by a processor.

A further aspect of the invention proposes a computer-readable medium on which an above-described program element is stored.

### BRIEF DESCRIPTION OF THE DRAWINGS

FIG. 1 is a schematic drawing of a level measurement device parameterisation system for configuring and/or parameterising a level measurement device in accordance with an embodiment of the invention.

FIG. 2 shows an example of a method for creating complete configuration information and/or parameterisation information for a level measurement device in accordance with an embodiment of the invention.

FIG. 3 shows an example of a functional simplified construction of a level measurement device parameterisation system in accordance with an embodiment of the invention.

FIG. 4 is a simplified drawing of an ordering process using a level measurement device parameterisation system in accordance with an embodiment of the invention.

### DETAILED DESCRIPTION OF THE DRAWINGS

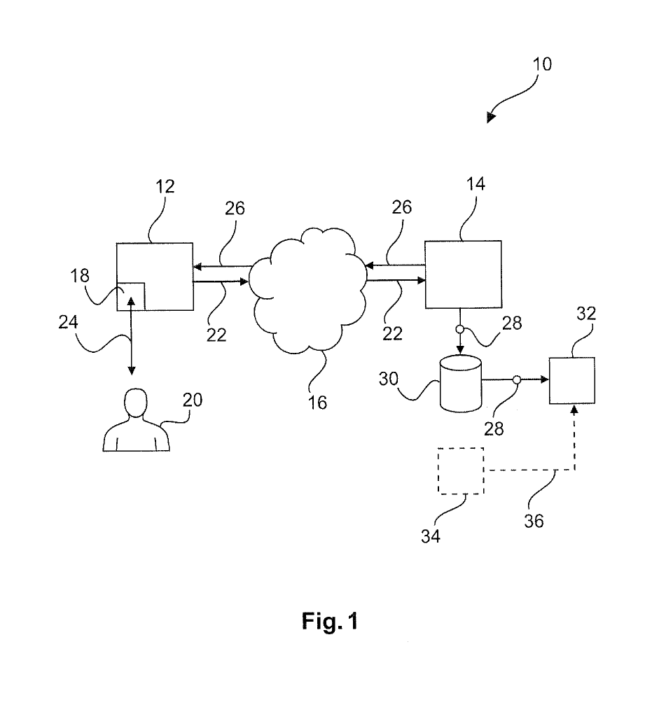

FIG. 1 is a simplified schematic drawing of a level measurement device parameterisation system 10, which comprises a user computer 12 and a central computer 14. There is a data communications link between the user computer 12 and the central computer 14, this data communications link being established via an IP-based data network 16 in the example shown. For this purpose, both the user computer 12 and the central computer 14 are connected to the data network 16, for example via a cable link. The user computer 12 comprises a user interface 18, via which a user 20 creates configuration instructions and parameterisation instructions 22 by way of user inputs 24, using the user computer 12. These configuration and parameterisation instructions 22 are transmitted to the central computer 14 via the data network 16. The central computer 14 is configured to transmit control information 26 to the user computer 12 to provide the user interface 18. This control information 26 may for example be display information to create a Web page in a browser window of the user interface 18. In this context, the control information 26 may for example be based on HTML, Java, XML or similar information. In this context, the intelligent functions required for providing the user interface 18 are basically implemented in the central computer 14. This may advantageously reduce the required hardware on the user computer 12 or at the user interface 18. In other words, the user computer 12 having the user interface 18 can only provide the necessary functionalities, so as to keep both installation and maintenance outlay and costs low.

The central computer 14 is configured to create at least some of the configuration and/or parameterisation information 28 on the basis of the configuration and parameterisation instructions 22. This configuration information and/or parameterisation information 28 can be stored in a storage unit 30. This storage unit 30 may for example comprise a hard disk memory, a removable medium, RAM or similar memory. An advantage of storing the configuration information and/or parameterisation information 28 in a storage unit 30 is that this information can be available for further method steps or applications over a relatively long period.

The configuration information and/or parameterisation information 28 can be read from the storage unit 30 and transferred into the level measurement device 32 via a parameterisation device (not shown) for example.

In addition, a level measurement device manager 34 is shown, and is connected to the level measurement device 32 via a parameterisation link 36. The level measurement device manager 34 may for example be a device type manager (DTM) by means of which the level measurement device 32 can be parameterised. The level measurement device manager 34 and the parameterisation link 36 are drawn in dashes to clarify that this is an alternative variant for configuring or parameterising the level measurement device 32. In this context, the user interface 18 of the user computer 12 is configured in such a way that it substantially corresponds to the configuration of a user interface of the level measurement device manager 34. In other words, the user 20 is offered a substantially identical graphical user interface and comparable input options and interaction options at the user interface 18 to those implemented in the level measurement device manager 34. This can advantageously improve the effectiveness of the use of the user interface 18 by the user 20.

The user interface 18 on the user computer 12 is provided independently of the operating system by way of a corresponding configuration of the user computer 12 and the central computer 14. This may for example be achieved by using a pre-installed web browser on the user computer 12 and making use of Web applications on the central computer 14.

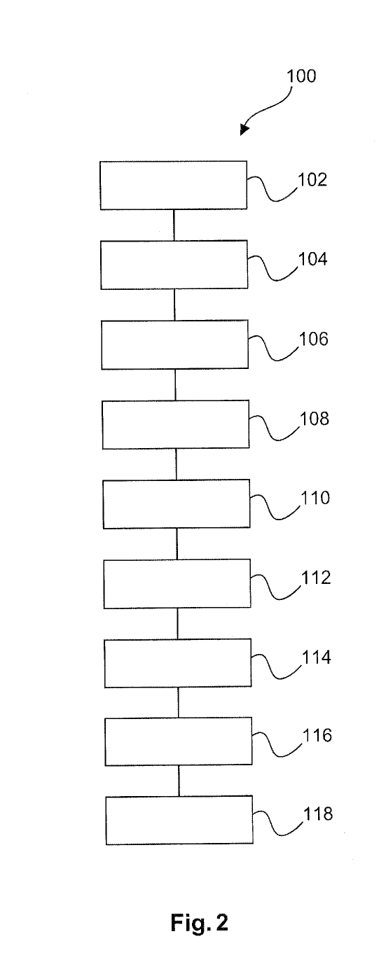

FIG. 2 shows in simplified form a method 100 for creating complete configuration information and/or parameterisation information 28. In this context, in a first step 102 a Web application is provided on a central computer. The Web application comprises at least all the functions of a level measurement device manager which are required for creating complete configuration information and/or parameterisation information. In a further step 104, the central computer transmits control information to the user computer to provide the user interface. In a further step 106, an operating-system-independent user interface is provided on a user computer. A further step 108 provides that a data communications link is established between the user computer and the central computer. Subsequently, in a further step 110, configuration instructions and parameterisation instructions are created on the basis of user inputs via the user interface on the user computer. In the next step 112, the configuration instructions and parameterisation instructions are transmitted from the user computer to the central computer. In step 114, the central computer creates complete configuration information and/or parameterisation information, based on the transmitted configuration instructions and parameterisation instructions, for a level measurement device. In a further step 116, the configuration information and/or parameterisation information is stored in a storage unit, the storage unit being configured to be connectable to the central computer and/or to the user computer and further being configured to store configuration information and parameterisation information. A further step 118, shown in the example method 100 shown, involves transferring configuration information and/or parameterisation information, created by the central computer and/or stored in the storage unit, into a level measurement device.

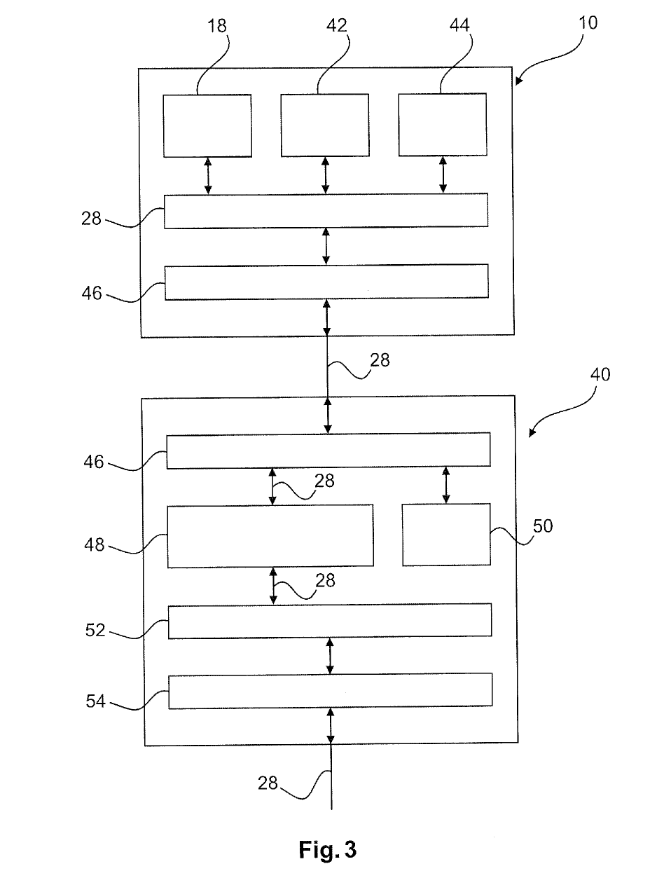

FIG. 3 shows a simplified example of a sub-region of a level measurement device parameterisation system 10, which cooperates with a framework application 40. In this context, the level measurement device parameterisation system 10 comprises a user interface 18 which creates configuration information and/or parameterisation information by way of a user computer and a central computer (see example in FIG. 1).

In addition, an export functionality 42 and an import functionality 44 are provided, which provide an additional data exchange option by way of reading or storing configuration information and/or parameterisation information 28. The created configuration information and/or parameterisation information 28 is provided via a framework application interface 46 of the framework application 40. This exchange of information may for example take place in software on the user computer 12 or in the central computer 14 (see FIG. 1). After the configuration information and/or parameterisation information 28 is exchanged via a framework application interface 46 in the framework application 40, the framework application 40 converts the data into a specific format for the framework application 40 using an information converter 48. The framework application 40 is further configured to start up at least part of the level measurement device parameterisation system 10 via a start-up module 50. This may take place for example by way of a button on the graphical user interface of the framework application 40. The configuration information and/or parameterisation information 28 provided by the information converter 48 are stored in a memory 52 in the framework application 40. As a result, the data and information for the device settings provided in this manner can be stored or loaded in the specific format for the framework application 40. The framework application 40 may further comprise an import/export functionality for storing and loading specific device settings on the level of the framework application 40.

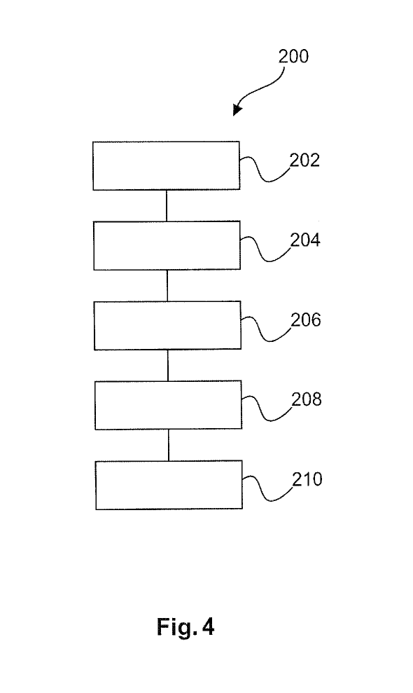

FIG. 4 shows by way of example, in simplified form, a method 200 for ordering a level measurement device using a level measurement device parameterisation system 10 according to the invention. In a first step 202, an order database comprising configuration information and parameterisation information is provided. In a second step 204, the configuration information and/or parameterisation information is read from the order database. This may for example involve loading a configuration file. In a further step 206, the configuration information and/or parameterisation information is transmitted into a level measurement device. In step 208, the level measurement device is transported to the place of use. Finally, in a step 210, the level measurement device is installed and set in operation at the final place of use thereof.

The advantage of this method is that, in particular in step 210 when the level measurement device is installed and set in operation, no repeated or additional configuration or parameterisation is required, and this can reduce expenditure of time and costs.

For completeness, it should be noted that “comprising” and “having” do not exclude the possibility of other elements or steps, and “a” or “one” does not exclude the possibility of a plurality. It should further be noted that features or steps which have been disclosed with reference to one of the above embodiments may also be used in combination with other features or steps of other above-disclosed embodiments. Reference numerals in the claims should not be treated as limiting.

1. A level measurement device parameterisation system for configuring and/or parameterising a level measurement device, comprising a user computer having a user interface; and
a central computer;
wherein there is a data communications link between the central computer and the user computer;
wherein the user computer is configured to create configuration instructions and parameterisation instructions on the basis of user inputs via the user interface, and to transmit them to the central computer;
wherein the central computer is configured to transmit control information for creating the user interface to the user computer, and to create at least part of the configuration information and/or parameterisation information for a level measurement device on the basis of the configuration instructions and parameterisation instructions.

2. The level measurement device parameterisation system according to claim 1, wherein the central computer is configured to create complete configuration information and/or parameterisation information for the level measurement device on the basis of the configuration instructions and parameterisation instructions.

3. The level measurement device parameterisation system according to claim 1, wherein the central computer and the user computer are further configured to create the configuration information and/or parameterisation information by way of functionalities of a level measurement device manager.

4. The level measurement device parameterisation system according to claim 1, wherein the user interface of the user computer is configured to provide a user with all the necessary functions of the level measurement device manager for creating the complete configuration information and/or parameterisation information.

5. The level measurement device parameterisation system according to claim 1, wherein the configuration of the user interface of the user computer substantially corresponds to the configuration of a user interface of the level measurement device manager.

6. The level measurement device parameterisation system according to claim 1, wherein the user computer and the central computer are configured to provide the user interface on the user computer independently of the operating system.

7. The level measurement device parameterisation system according to claim 1, wherein the level measurement device parameterisation system on the user computer and on the central computer is configured as a Web application.

8. The level measurement device parameterisation system according to claim 1, further comprising a storage unit configured to store configuration information and/or parameterisation information created by the central computer.

9. A method for creating complete configuration information and/or parameterisation for ordering a level measurement device, comprising the steps of:
providing a Web application on a central computer, wherein the Web application comprises at least all the functions of a level measurement device manager which are required for creating complete configuration information and/or parameterisation information;
transmitting, using the central computer, control information to the user computer to provide the user interface;
providing an operating-system-independent user interface on the user computer;
establishing a data communications link between the user computer and the central computer;
creating configuration instructions and parameterisation instructions on the basis of user inputs via the user interface on the user computer;
transmitting the configuration instructions and parameterisation instructions from the user computer to the central computer; and
creating, using the central computer, complete configuration information and/or parameterisation information for assembling and parameterising a level measurement device, the creation being based on the transmitted configuration instructions and parameterisation instructions.

10. The method according to claim 9, further comprising the step of
storing the configuration information and/or parameterisation information in a storage unit, which can be connected to the central computer and/or to the user computer and which is configured to store configuration information and parameterisation information.

11. The method according to claim 10, further comprising the step of
transferring configuration information and/or parameterisation information, created by the central computer and/or stored in the storage unit, into a level measurement device.

12. The method according to claim 10, wherein the operating-system-independent user interface is provided on the user computer from a framework application.

13. The method according to claim 10, wherein storing the configuration and/or parameterisation information comprises providing the created configuration information and/or parameterisation information for the framework application.

14. A program element for creating configuration information and/or parameterisation information for a level measurement device, which carries out the steps of the method according to claim 9 when implemented by a processor.

15. A computer-readable medium on which a program element according to claim 14 is stored.
